(19) United States
(12) Patent Application Publication
(10) Pub. No.: US 2006/0204114 A1
(43) Pub. Date: Sep. 14, 2006

(54) Multi-resolution motion estimator and method for estimating a motion vector

(76) Inventors: Jong-sun Kim, Yongin-si (KR); Kyoung-mook Lim, Hwaseong-si (KR); Hee-young Seo, Suwon-si (KR); Jae-young Beom, Hwaseong-si (KR); Jae-hong Park, Seongnam-si (KR); Min-ho Won, Seoul (KR)

Correspondence Address: LEE & MORSE, P.C., 1101 WILSON BOULEVARD, SUITE 2000, ARLINGTON, VA, 22209, US

(21) Appl. No.: 11/365,850

(22) Filed: Mar. 2, 2006

(30) Foreign Application Priority Data
Mar. 9, 2005 (KR) 10-2005-0019569

(51) Int. Cl. G06K 9/36; H04N 7/12

(52) U.S. Cl. 382/236; 348/416.1

(57) ABSTRACT

A hierarchical motion estimator and a motion vector generating method for compressing image data, having both a high frequency component and a low frequency component, rapidly and correctly compress the image data without increasing memory requirements. The motion estimator includes a first data processing block, a second data processing block and a motion estimation block. The motion vector generating method generates current image hierarchical data, generates reference image hierarchical data and then generates a motion vector based on high-frequency current image hierarchical data, low-frequency current image hierarchical data, high-frequency reference image hierarchical data and low-frequency reference image hierarchical data.

### BACKGROUND OF THE INVENTION

1. Field of the Invention

The present invention relates to motion picture compression. More particularly, the present invention relates to a multi-resolution motion estimator suitable for compressing an image including both a high frequency component and a low frequency component.

2. Description of the Related Art

The basis of video data is a smallest unit cell called a picture element or a pixel. A plurality of pixel data constructs a single picture information piece and the picture information is accumulated to form video data to be reproduced. The number of pixels constructing a single frame is represented by the product of the number of horizontally arranged pixels by the number of vertically arranged pixels, such as 780×480. The amount of video data reproduced and displayed as an image on a television screen or a personal computer monitor is considerably large.

To reproduce the video data using a television receiver or a monitor, the video data must be stored in a specific storage medium and transmitted from the storage medium to the television receiver or the monitor. A memory with considerably large capacity and a long period of time are required for storing and transmitting the video data because, as noted above, the amount of video data is large. To overcome many shortcomings arising when the video data is stored or transmitted, techniques for compressing the video data have been proposed.

A current frame and frames before and after the current frame have temporal and spatial correlations. Video data corresponding to the current frame is very similar to video data corresponding to a frame before or after the current frame except during special cases, e.g., a scene change. Accordingly, the amount of video data of a current frame can be considerably reduced if the video data of the current frame is generated using video data of a previous frame. This is the core idea of the data compression technique.

A data compression process begins by comparing the current frame with the previous frame to determine whether the current frame has a portion identical to the corresponding portion of the previous frame. When the current frame has a portion identical to the corresponding portion of the previous frame, the portion of the current frame is displayed using video data of the corresponding portion of the previous frame. In other words, video data corresponding to the portion of the current frame is not stored, but data obtained by adding a motion vector to the previously stored video data is stored, significantly reducing the amount of data to be stored. Here, the motion vector has a value representing the position difference between a specific portion of the current frame and the corresponding portion of the previous frame.

It is not appropriate to use a pixel as a minimum area unit for comparing one frame to another frame because the pixel represents a very small area, i.e., such a comparison would take too long. Thus, a macro block corresponding to a plurality of pixels is used for comparing two frames to each other. The macro block can be an array of pixels, e.g., 4×4, 8×8, 16×16, etc.

As described above, the motion vector representing the position difference between corresponding portions of two frames is determined by a motion estimator. The motion estimator is needed to compress video signal data and store or transmit the compressed video signal data. It is important for the motion estimator to perform correct motion estimation using as simple a method as possible. For this, hierarchical motion estimation is typically used.

FIG. 1 illustrates an example of conventional motion estimators using the hierarchical motion estimation. Referring to FIG. 1, a conventional motion estimator has four search levels and estimates motion vectors using 8-bit data with respect to a current image and 8-bit data with respect to a reference image. The hierarchical motion estimator estimates a motion vector at each of the levels L3, L2, L1 and L0, and obtains a final motion vector at the lowest level L0.

The motion estimator estimates a motion vector MV3 at the highest level L3 using 8-bit data obtained by coding images, which are respectively obtained by scaling down the current image and the reference image by 1/64. The motion estimator estimates a motion vector MV2 at the level L2 using 8-bit data obtained by coding images, which are respectively obtained by scaling down the current image and the reference image by 1/16, and the motion vector MV3 estimated at the highest level L3. In addition, the motion estimator estimates a motion vector MV1 at the level L1 using 8-bit data obtained by coding images, which are respectively obtained by scaling down the current image and the reference image by ¼, and the motion vector MV2 estimated at the upper level L2. The motion estimator estimates the final motion vector MV at the lowest level L0 using 8-bit data obtained by coding the current image and the reference image and the motion vector MV1 estimated at the highest level L1. The current image and the reference images are scaled down using filters.

The conventional hierarchical motion estimator shown in FIG. 1 is effective for representing a flat background, e.g., a wall of a single color, because it handles 8-bit data. However, the conventional motion estimator requires a large memory bandwidth to read a large quantity of data for the reference image, a large memory capacity to accommodate the bandwidth and a large number of calculations for calculating the motion vectors.

FIG. 2 illustrates another example of conventional motion estimators using hierarchical motion estimation. Referring to FIG. 2, the motion estimator has four search levels. The motion estimator compares 8-bit data or 1-bit data with respect to the current image to 8-bit data or 1-bit data with respect to the reference image. The multi-resolution motion estimator estimates a final motion vector MV using eight data estimated at each of levels L3, L2, L1 and L0.

The motion estimator estimates a motion vector MV3 at the highest level L3 using 8-bit data with respect to the current image and the reference image and estimates motion vectors at the other levels L2, L1 and L0 using 1-bit data with respect to the current image and the reference image.

In comparison of the motion estimator of FIG. 2 to the motion estimator of FIG. 1, the motion estimator of FIG. 2 further includes quantizers used to transform 8-bit data into 1-bit data. When a single pixel is represented by 8 bits, the 8-bit data of the pixel is compared to a predetermined value and the 8-bit data is coded into 1-bit data for a case where the 8-bit data is larger than the predetermined value and a case where the 8-bit data is smaller than the predetermined value.

Specifically, two neighboring pixels have a considerably large difference between their values when the two neighboring pixels construct a contour. Thus, when the value of one pixel is 0, the value of the other pixel can be 1. On the other hand, when two neighboring pixels have similar values, e.g., a wall of a single color, both pixels can be represented by 0 or 1. In this manner, the 8-bit pixel can be represented by 1 bit data.

Referring to FIG. 2, the motion estimator uses the 1-bit data at the search levels L2, L1 and L0 other than the highest level L3. Thus, the motion estimator is effective for a portion having an abrupt variation of pixel data, e.g., a contour. However, it cannot correctly estimate motion vectors in other cases.

In general, 1-bit data loses information of the original image as a level increases and thus correct motion estimation is difficult to perform. To compensate for this, motion estimation using sub-sampled 8-bit data is carried out. See, for example, “New fast binary pyramid motion estimation for MPEG2 and HDTV encoding,” Xudong Song; Tihao Chiang; Xiaobing Lee; Ya-Qin Zhang; Circuits and Systems for Video Technology,” IEEE Trans. Circuits Syst. Video Tech., Volume: 10, No. 7, October, 2000, pp. 1015-1028.

However, even though the aforementioned technique is used, motion estimation is not correctly performed for a region having numerous low frequency components when only 1-bit data is used as a measurement value of motion estimation at the subsequent step.

### SUMMARY OF THE INVENTION

The present invention is therefore directed to compressing a image data signal using a motion estimator and method, which substantially overcome one or more of the problems due to the limitations and disadvantages of the related art.

It is a feature of an embodiment of the present invention to provide a hierarchical motion estimator for compressing image data, having both a high frequency component and a low frequency component, rapidly and correctly without increasing a memory bandwidth.

It is another feature of an embodiment of the present invention to provide a method for generating a motion vector, which compresses image data, having both a high frequency component and a low frequency component, rapidly and correctly without increasing memory capacity.

At least one of the above and other features and advantages of the present invention may be realized by providing a method for generating a motion vector for compressing a current image using a plurality of hierarchical data of the current image and a plurality of hierarchical data of a reference image, the method including generating a plurality of high-frequency current image hierarchical data representative of a high frequency component of the current image, generating a plurality of low-frequency current image hierarchical data representative of a low frequency component of the current image, generating a plurality of high-frequency reference image hierarchical data representative of a high frequency component of the reference image, generating a plurality of low-frequency reference image hierarchical data representative of a low frequency component of the reference image, and generating the motion vector using the plurality of high-frequency current image hierarchical data, the plurality of low-frequency current image hierarchical data, the plurality of high-frequency reference image hierarchical data and the plurality of low-frequency reference image hierarchical data.

Generating the plurality of high-frequency current image hierarchical data may include generating first high-frequency current image hierarchical data using current image data, scaling down the current image using a first scale-down ratio to generate first scale-down current image data, generating second high-frequency current image hierarchical data using the first scale-down current image data, scaling down the first scale-down current image data using a second scale-down ratio to generate second scale-down current image data, outputting the second scale-down current image data as the low frequency current image hierarchical data, and generating third high-frequency current image hierarchical data using the second scale-down current image data.

Generating the plurality of high-frequency reference image hierarchical data may include generating first high-frequency reference image hierarchical data using reference image data, scaling down the reference image using the first scale-down ratio to generate first scale-down reference image data, generating second high-frequency reference image hierarchical data using the first scale-down reference image data, scaling down the first scale-down reference image data using the second scale-down ratio to generate second scale-down reference image data, outputting the second scale-down reference image data as the low-frequency reference image hierarchical data, and generating third high-frequency reference image hierarchical data using the second scale-down reference image data.

Generating the motion vector may include generating a plurality of hierarchical motion vectors, generating first expanded current image hierarchical data by expanding the low-frequency current image hierarchical data by a first expansion ratio, and generating second expanded current image hierarchical data by expanding the low-frequency current image hierarchical data by a second expansion ratio.

Generating the plurality of hierarchical motion vectors may include estimating a third hierarchical motion vector using the third high-frequency current image hierarchical data, the third high-frequency reference image hierarchical data, the low-frequency current image hierarchical data and the low-frequency reference image hierarchical data, estimating a second hierarchical motion vector using the second high-frequency current image hierarchical data, the second high-frequency reference image hierarchical data, the first expanded current image hierarchical data, the low-frequency reference image hierarchical data and the third hierarchical motion vector, and estimating a first hierarchical motion vector using the first high-frequency current image hierarchical data, the first high-frequency reference image hierarchical data, the second expanded current image hierarchical data, the low-frequency reference image hierarchical data and the second hierarchical motion vector.

At least one of the above and other features and advantages of the present invention may be realized by providing multi-resolution motion estimator including a first data processing block outputting first hierarchical data with respect to a current image, second hierarchical data with respect to an image obtained by scaling down the current image by a first scale-down ratio, second scale-down image data obtained by scaling down the current image by a second scale-down ratio, and third hierarchical data with respect to the second scale-down image data, a second data processing block outputting fourth hierarchical data with respect to a reference image, fifth hierarchical data with respect to an image obtained by scaling down the reference image by the first scale-down ratio, fourth scale-down image data obtained by scaling down the reference image by the second scale-down ratio, and sixth hierarchical data with respect to the fourth scale-down image data, and a motion estimation block respectively generating motion vectors at a plurality of levels using the first through sixth hierarchical data, the second scale-down video data and the fourth scale-down video data, the motion vectors being generated at the respective levels using hierarchical data having exclusive characteristic among the first through sixth hierarchical data, the second scale-down image data and the fourth scale-down image data.

The hierarchical data having exclusive characteristic may be hierarchical data representative of neighbouring pixels having a large difference between them and hierarchical data representative of neighbouring pixels having a negligible difference between them.

The first data processing block may include a first filter outputting first scale-down image data obtained by scaling down the current image by the first scale-down ratio, a second filter outputting the second scale-down image data obtained by scaling down the current image by the second scale-down ratio using the first scale-down image data, a first quantizer transforming the current image into the first hierarchical data, a second quantizer transforming the first scale-down image data into the second hierarchical data, and a third quantizer transforming the second scale-down image data into the third hierarchical data.

The second data processing block may include a third filter outputting third scale-down image data obtained by scaling down the reference image by the first scale-down ratio, a fourth filter outputting the fourth scale-down image data obtained by scaling down the third scale-down image data by the second scale-down ratio, a fourth quantizer transforming the reference image into the fourth hierarchical data, a fifth quantizer transforming the third scale-down image data into the fifth hierarchical data, and a sixth quantizer transforming the fourth scale-down image data into the sixth hierarchical data.

The motion estimation block may include an expander expanding the second scale-down image data in a first expansion ratio to generate first expanded image data and expanding the second scale-down image data to a size of the current image to generate second expanded image data, wherein the first expansion ratio is a reciprocal of the first scale-down ratio, a first hierarchical motion estimation unit generating a first motion vector using the first hierarchical data, the fourth hierarchical data, the fourth scale-down image data, the second expanded image data and a second motion vector, a second hierarchical motion estimation unit generating the second motion vector using the second hierarchical data, the fifth hierarchical data, the fourth scale-down image data, the first expanded image data and a third motion vector, and a third hierarchical motion estimation unit generating the third motion vector using the third hierarchical data, the sixth hierarchical data, the second scale-down image data and the fourth scale-down image data.

At least one of the above and other features and advantages of the present invention may be realized by providing an article of manufacture having a machine-accessible medium including data that, when accessed by a machine, cause the machine to generate a plurality of high-frequency current image hierarchical data representative of a high frequency component of the current image, generate a plurality of low-frequency current image hierarchical data representative of a low frequency component of the current image, generate a plurality of high-frequency reference image hierarchical data representative of a high frequency component of the reference image, generate a plurality of low-frequency reference image hierarchical data representative of a low frequency component of the reference image using the reference image, and generate the motion vector using the plurality of high-frequency current image hierarchical data, the plurality of low-frequency current image hierarchical data, the plurality of high-frequency reference image hierarchical data and the plurality of low-frequency reference image hierarchical data.

At least one of the above and other features and advantages of the present invention may be realized by providing an image data processor executing a method for generating a motion vector for compressing a current image using a plurality of hierarchical data using the current image and a plurality of hierarchical data using a reference image, the method including generating a plurality of high-frequency current image hierarchical data representative of a high frequency component of the current image, generating a plurality of low-frequency current image hierarchical data representative of a low frequency component of the current image, generating a plurality of high-frequency reference image hierarchical data representative of a high frequency component of the reference image, generating a plurality of low-frequency reference image hierarchical data representative of a low frequency component of the reference image, and generating the motion vector using the plurality of high-frequency current image hierarchical data, the plurality of low-frequency current image hierarchical data, the plurality of high-frequency reference image hierarchical data and the plurality of low-frequency reference image hierarchical data.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates an example of conventional motion estimators used in hierarchical motion estimation;

FIG. 2 illustrates another example of conventional motion estimators used in hierarchical motion estimation;

FIG. 3 illustrates a block diagram of a multi-resolution motion estimator according to an embodiment of the present invention; and

FIGS. 4A, 4B and 4C are diagrams for explaining the concept of obtaining SADs from 8-bit hierarchical data, FIG. 4A illustrating a search by +1 from a reference point in a y-direction, FIG. 4B illustrating a search by +2 in the y-direction, and FIG. 4C illustrating a search by +3 in the y-direction.

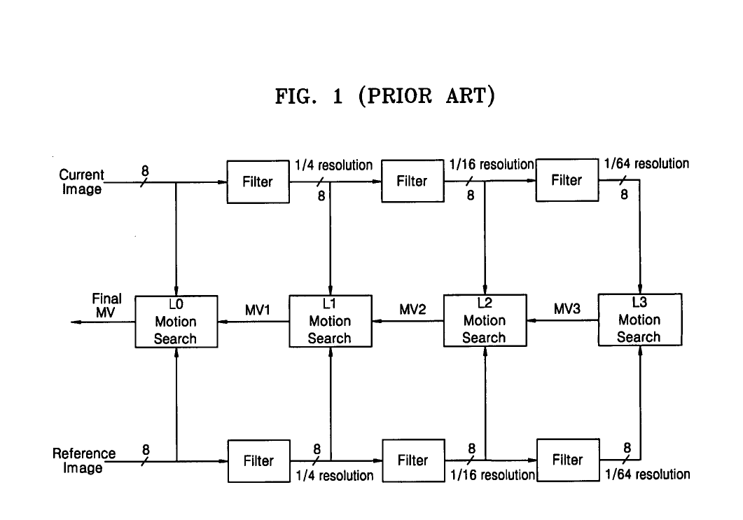

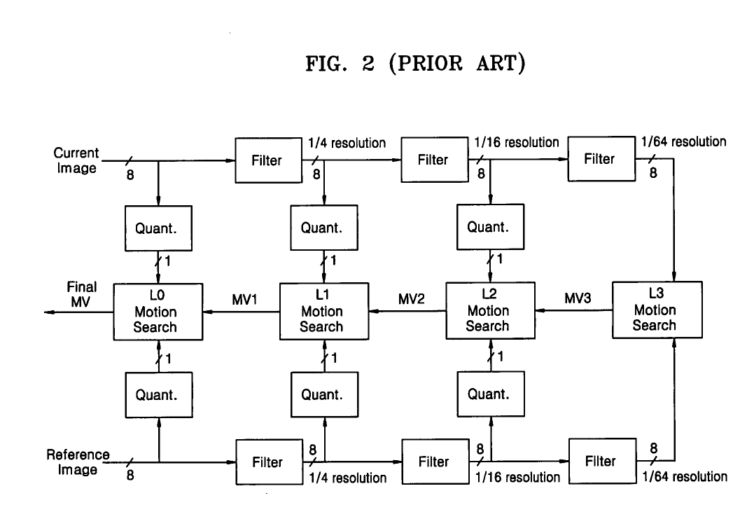

### DETAILED DESCRIPTION OF THE INVENTION

Korean Patent Application No. 10-2005-0019569, filed on Mar. 9, 2005, in the Korean Intellectual Property Office, and entitled “A multi-resolution motion estimator and a method for estimating the motion vector,” is incorporated by reference herein in its entirety.

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout the drawings, like reference numerals refer to like elements.

Hierarchical motion estimation performed in a motion estimator according to an embodiment of the present invention may include three levels, e.g., level 1, level 2 and level 3. Level 3 is the highest level and level 1 is the lowest level. However, four or more levels may be used in accordance with the present invention.

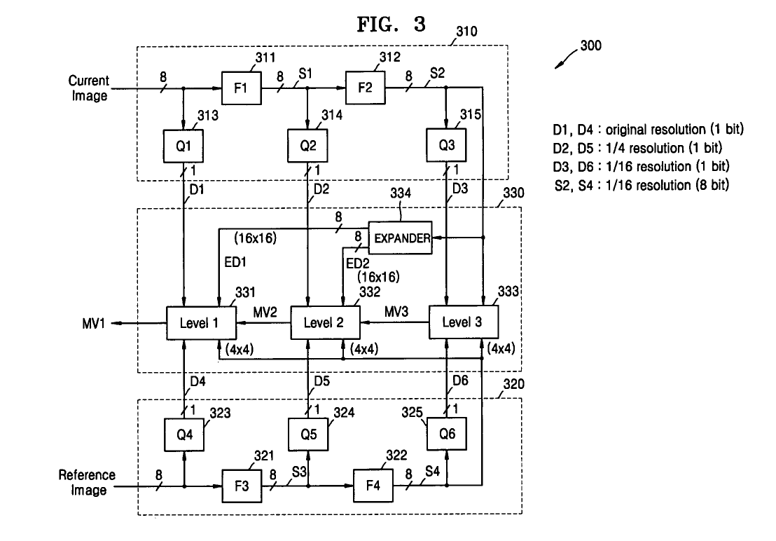

FIG. 3 illustrates a block diagram of a multi-resolution motion estimator 300 according to an embodiment of the present invention. Referring to FIG. 3, the multi-resolution motion estimator 300 may include a first data processing block 310, a second data processing block 320 and a motion estimation block 330.

The first data processing block 310 may include a first filter 311, a second filter 312, a first quantizer 313, a second quantizer 314 and a third quantizer 315. The first filter 311 may output first scale-down image data S1 obtained by scaling down a current image. The second filter 312 may output second scale-down image data S2 obtained by scaling down the current image in a second scale-down ratio using the first scale-down image data S1. The first quantizer 313 may transform the current image into first hierarchical data D1. The second quantizer 314 may transform the first scale-down image data S1 into second hierarchical data D2. The third quantizer 315 may transform the second scale-down image data S2 into third hierarchical data D3.

The second data processing block 320 may include a fourth filter 321, a fifth filter 322, a fourth quantizer 323, a fifth quantizer 324 and a sixth quantizer 325. The fourth filter 321 may output third scale-down image data S3 obtained by scaling down a reference image. The fifth filter 322 may output fourth scale-down image data S4 obtained by scaling down the reference image in the second scale-down rate using the third scale-down image data S3. The fourth quantizer 323 may transform the reference image into fourth hierarchical data D4. The fifth quantizer 324 may transform the third scale-down image data S3 into fifth hierarchical data D5. The sixth quantizer 325 may transform the fourth scale-down image data S4 into sixth hierarchical data D6.

The motion estimation block 330 may include a first hierarchical motion estimation unit 331, a second hierarchical motion estimation unit 332, a third hierarchical motion estimation unit 333 and an expander 334. The first hierarchical motion estimation unit 331 may generate a first motion vector MV1 using the first hierarchical data D1, the fourth hierarchical data D4, the fourth scale-down image data S4, second expanded image data ED1 and a second motion vector MV2. The second hierarchical motion estimation unit 332 may generate the second motion vector MV2 using the second hierarchical data D2, the fifth hierarchical data D5, the fourth scale-down image data S4, first expanded image data ED2 and a third motion vector MV3.

The third hierarchical motion estimation unit 333 may generate the third motion vector MV3 using the third hierarchical data D3, the sixth hierarchical data D6, the second scale-down image data S2 and the fourth scale-down image data S4. The expander 334 may expand the second scale-down image data S2 by a first expansion ratio to generate the first expanded image data ED2 and the second scale-down image data S2 to the size of the current image to generate the second expanded image data ED1.

The first hierarchical data D1 and the fourth hierarchical data D4 provided to the first hierarchical motion estimation unit 331 may be 1-bit data obtained by respectively quantizing the current image and the reference image. When a motion vector is estimated using the first hierarchical data D1 and the fourth hierarchical data D4, data having numerous high frequency components can be effectively compressed. In other words, data can be effectively compressed in the case when adjacent pixels have a large difference between their values, e.g., the contour of an object.

The second expanded image data ED1 and the fourth scale-down image data S4 provided to the first hierarchical motion estimation unit 331 may be 8-bit data with respect to images obtained by respectively scaling down the current image and the reference image by the second scale-down ratio. When a motion vector is estimated using the second expanded image data ED1 and the fourth scale-down image data S4, data having lots of DC components can be effectively compressed. That is, data can be effectively compressed when adjacent pixels barely have a difference between their values, e.g., a wall of a single color.

The second hierarchical data D2 and the fifth hierarchical data D5 provided to the second hierarchical motion estimation unit 332 may correspond to the first hierarchical data D1 and the fourth hierarchical data D4 provided to the first hierarchical motion estimation unit 331. In addition, the first expanded image data ED2 and the fourth scale-down image data S4 provided to the second hierarchical motion estimation unit 332 may correspond to the second expanded image data ED1 and the fourth scale-down image data S4 provided to the first hierarchical motion estimation unit 331. Accordingly, explanation for the second hierarchical motion estimation unit 332 is omitted. Explanation regarding the third hierarchical motion estimation unit 333 is similarly omitted.

Hierarchical data suitable for a case that adjacent pixels have a large difference between their values, e.g., the contour of an object, and hierarchical data suitable for a case that adjacent pixels have a negligible difference between their values, e.g., a wall of a single color, are mutually exclusive. In other words, an advantage of one type of hierarchical data in one case may become a disadvantage in another case. The motion estimation units 331 and 332 used in the hierarchical motion estimator of the present invention obtain sum of absolute differences (SADs) considering the two exclusive cases and generate optimum motion vectors using the SADs.

Here, a SAD is a variable for representing a degree of similarity of macro blocks compared with each other and may be obtained by calculating absolute values of differences of pixels and summing up the absolute values. A small SAD indicates that the two macro blocks are similar to each other and a large SAD indicates that the two macro blocks are different from each other.

The first scale-down ratio may be 1/4 and the second scale-down ratio may be 1/16. If another scale-down ratio is needed, 1/64 may be appropriate. The first hierarchical data D1 through the sixth hierarchical data D6 may be one-bit data. The first expanded image data ED2 and the second expanded image data ED1 may be provided in a 16×16 array and the fourth scale-down image data S4 may be provided in a 4×4 array.

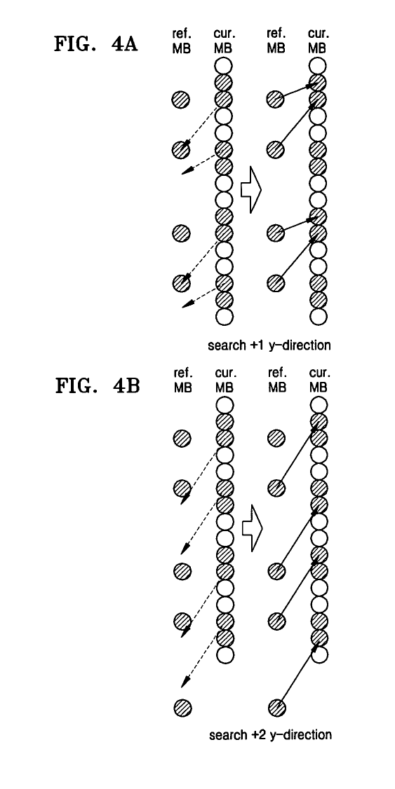

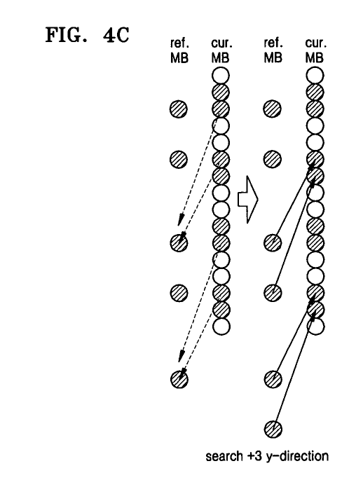

The first hierarchical motion estimation unit 331 may search the second expanded image data ED1 for data corresponding to the fourth scale-down image data S4 and obtain a SAD with respect to the data. The second hierarchical motion estimation unit 332 may search the first expanded image data ED2 for the data corresponding to the fourth scale-down image data S4 and obtain a SAD with respect to the data. This will be explained in detail with reference to FIGS. 4A, 4B and 4C.

FIGS. 4A, 4B and 4C illustrate diagrams for explaining the concept of obtaining SADs from 8-bit hierarchical data. FIG. 4A illustrates a search by +1 from a reference point in a y-direction, FIG. 4B illustrates a search by +2 from the reference point in the y-direction, and FIG. 4C illustrates a search by +3 from the reference point in the y-direction.

The left hand sides of FIGS. 4A, 4B and 4C represent a conventional method of searching points of a reference macro block (ref. MB) for points corresponding to points constructing a current macro block (cur. MB) and the right hand sides thereof represent a method proposed to overcome one or more problems of the conventional search method, which searches the points constructing the current macro block for points corresponding to the points constructing the reference macro block.

Referring to the left hand side of FIG. 4A, only eight of sixteen points of the current macro block are marked, i.e., shaded, as corresponding points. When search points correspond to reference points plus 1 in the y-direction, the differences between pairs of two points indicated by arrows should be summed to obtain SADs with respect to 4×4 points including the search points and corresponding points of the current macro block. However, the reference macro block has only two points corresponding to the search points. The reference macro blocks shown in the left hand sides of FIGS. 4B and 4C also have only two points corresponding to search points. The conventional method calculates the SADs with information about points that do not exist and estimates motion vectors using the SADs having an error. Accordingly, when image data is compressed using the motion vectors, a picture reproduced using the image data may have a quality problem.

Referring to the right hand side of FIG. 4A, the present invention searches the points of the current macro block for points corresponding to the points constructing the reference macro block. The difference between the left and right hand sides can be easily understood by the arrow directions illustrated. The present invention can solve the problem of the conventional technique that cannot find corresponding points.

The SAD finally determined in the first and second motion estimation units 331 and 332 can be represented as follows.

[Equation 1]
SAD=An×8Bit-SAD+Bn×1Bit-SAD+Cn×B-MV

Here, A, B and C are constants determined according to a level n, where n is an integer. B-MV at each level is a motion vector determined in a previous hierarchical motion estimation unit. 8 Bit-SAD is a SAD obtained using 8-bit hierarchical data and 1 Bit-SAD is a SAD obtained using 1-bit hierarchical data. B and C are zero in the third hierarchical motion estimation unit 333.

When SADs represented by Equation 1 are obtained in the respective hierarchical motion estimation units and then a motion vector having a minimum SAD is selected and output, the motion vector in consideration of the aforementioned two exclusive cases is obtained. The 8-bit hierarchical data used in Equation 1 is not 8-bit data with respect to a separate scale-down image corresponding to each level, but uses the 8-bit data of the third hierarchical data D3 without change or simply expanded by the expander 334. Thus, additional memory is not needed and a data bandwidth of a memory is not lost. In addition, SADs are obtained only for 4×4 points, thus reducing the number of calculations.

A motion vector generating method according to an embodiment of the present invention generates a motion vector for compressing a current image using a plurality of hierarchical data using the current image and a plurality of hierarchical data using a reference image.

The motion vector generating method may include generating a current image hierarchical data, generating a reference image hierarchical data and generating a motion vector.

In generating the current image hierarchical data, first high-frequency current image hierarchical data may be generated using current image data, the current image may be scaled down by a first scale-down ratio using the current image data to generate first scale-down current image data and second high-frequency current image hierarchical data may be generated using the first scale-down current image data. Thereafter, second scale-down current image data scaled down from the current image by a second scale-down ratio may be generated using the first scale-down current image data and may be output as the low-frequency current image hierarchical data. Third high-frequency current image hierarchical data may be generated using the second scale-down current image data.

In generating the reference image hierarchical data, first high-frequency reference image hierarchical data may be generated using reference image data, the current image may be scaled down by the first scale-down ratio using the reference image data to generate first scale-down reference image data and second high-frequency reference image hierarchical data may be generated using the first scale-down reference image data. Subsequently, second scale-down reference image data scaled down from the current image by the second scale-down ratio may be generated using the first scale-down reference image data and may be output as the low-frequency reference image hierarchical data. Third high-frequency reference image hierarchical data may be generated using the second scale-down reference image data.

In generating the motion vector, a plurality of hierarchical motion vectors may be generated, and first expanded current image hierarchical data may be obtained by expanding the low-frequency current image hierarchical data in a first expansion ratio and second expanded current image hierarchical data may be obtained by expanding the low-frequency current image hierarchical data in a second expansion ratio.

The plurality of hierarchical motion vectors may be generated by estimating a third hierarchical motion vector using the third high-frequency current image hierarchical data, the third high-frequency reference image hierarchical data, the low-frequency current image hierarchical data and the low-frequency reference image hierarchical data, estimating a second hierarchical motion vector using the second high-frequency current image hierarchical data, the second high-frequency reference image hierarchical data, the first expanded current image hierarchical data, the low-frequency reference image hierarchical data and the third hierarchical motion vector, and estimating a first hierarchical motion vector using the first high-frequency current image hierarchical data, the first high-frequency reference image hierarchical data, the second expanded current image hierarchical data, the low-frequency reference image hierarchical data and the second hierarchical motion vector.

The third hierarchical motion vector may be estimated by calculating a first SAD(3) using the third high-frequency current image hierarchical data and the third high-frequency reference image hierarchical data, calculating a second SAD(3) using the low-frequency current image hierarchical data and the low-frequency reference image hierarchical data, calculating SAD(3) satisfying Equation 2, and outputting a motion vector having a minimum value among the values of SAD(3) as the third hierarchical motion vector.

[Equation 2]
SAD(3)=A3×first SAD(3)+B3×second SAD(3)
where A3 and B3 are arbitrary constants.

Here, the second SAD(3) may be obtained by searching predetermined points represented by the low-frequency reference image hierarchical data for points corresponding to predetermined points represented by the low-frequency current image hierarchical data, calculating absolute values of differences between the searched points and accumulating the absolute values.

The second hierarchical motion vector may be estimated by calculating a first SAD(2) using the second high-frequency current image hierarchical data and the second high-frequency reference image hierarchical data, calculating a second SAD(2) using the first expanded current image hierarchical data and the low-frequency reference image hierarchical data, calculating SAD(2) satisfying Equation 3, and outputting a motion vector having a minimum value among the values of SAD(2) as the second hierarchical motion vector.

[Equation 3]
SAD(2)=A2×first SAD(2)+B2×second SAD(2)+C2×MV3
where A2, B2 and C2 are constants and MV3 is the third hierarchical motion vector.

Here, the second SAD(2) may be obtained by searching predetermined points represented by the low-frequency reference image hierarchical data for points corresponding to predetermined points represented by the first expanded current image hierarchical data, calculating absolute values of differences between the searched points and accumulating the absolute values.

The first hierarchical motion vector may be generated by calculating a first SAD(1) using the first high-frequency current image hierarchical data and the first high-frequency reference image hierarchical data, calculating a second SAD(1) using the second expanded current image hierarchical data and the low-frequency reference image hierarchical data, calculating SAD(1) satisfying Equation 4, and outputting a motion vector having a minimum value among the values of SAD(1) as the first hierarchical motion vector.

[Equation 4]
SAD(1)=A1×first SAD(1)+B1×second SAD(1)+C1×MV2
where A1, B1 and C1 are constants and MV2 is the second hierarchical motion vector.

Here, the second SAD(1) may be obtained by searching predetermined points represented by the low-frequency reference image hierarchical data for points corresponding to predetermined points represented by the second expanded current image hierarchical data, calculating absolute values of differences between the searched points and accumulating the absolute values.

The constants An, Bn and Cn may be determined in accordance with results of a simulation in which various combinations of the constants An, Bn and Cn for various image sequence inputs are applied to Equations [2] to [4], and an optimal combination of these constants for the most image sequence inputs is selected.

A recording medium that converts the method for generating a motion vector for compressing the current image using a plurality of hierarchical data using the current image and a plurality of hierarchical data using a reference image into instruction words and stores them is included in the scope of the present invention. In other words, while embodiments of the present invention have been described above relative to a hardware implementation, the processing of the present invention may be implemented in software, e.g., using an article of manufacture having a machine-accessible medium including data that, when accessed by a machine, cause the machine to compress the image in accordance with methods of the present invention. Furthermore, a video data processor that executes the motion vector generating method is also included in the scope of the present invention.

As described above, the present invention performs motion estimation using 8-bit hierarchical data of the lowest level as well as 1-bit hierarchical data in order to solve the problem of the conventional motion estimator using 1-bit data. Accordingly, motion estimation can be carried out more accurately both in a region having numerous low frequency components and in a region having numerous high frequency components. Here, the 8-bit data is not 8-bit data with respect to a separate scale-down image corresponding to each level, but uses the 8-bit data of the second level (reference macro block) without change or expanded from the 8-bit data of the second level (current macro block). Thus, additional memory is not required and memory bandwidth is not lost. In addition, SADs are obtained only for 4×4 points, reducing a number of calculations.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method for generating a motion vector for compressing a current image using a plurality of hierarchical data of the current image and a plurality of hierarchical data of a reference image, the method comprising:
generating a plurality of high-frequency current image hierarchical data representative of a high frequency component of the current image;
generating a plurality of low-frequency current image hierarchical data representative of a low frequency component of the current image;
generating a plurality of high-frequency reference image hierarchical data representative of a high frequency component of the reference image;
generating a plurality of low-frequency reference image hierarchical data representative of a low frequency component of the reference image; and
generating the motion vector using the plurality of high-frequency current image hierarchical data, the plurality of low-frequency current image hierarchical data, the plurality of high-frequency reference image hierarchical data and the plurality of low-frequency reference image hierarchical data.

2. The method as claimed in claim 1, wherein generating the plurality of high-frequency current image hierarchical data comprises:
generating first high-frequency current image hierarchical data using current image data;
scaling down the current image using a first scale-down ratio to generate first scale-down current image data;
generating second high-frequency current image hierarchical data using the first scale-down current image data;
scaling down the first scale-down current image data using a second scale-down ratio to generate second scale-down current image data;
outputting the second scale-down current image data as the low frequency current image hierarchical data; and
generating third high-frequency current image hierarchical data using the second scale-down current image data.

3. The method as claimed in claim 2, wherein the generating the plurality of high-frequency reference image hierarchical data comprises:
generating first high-frequency reference image hierarchical data using reference image data;
scaling down the reference image using the first scale-down ratio to generate first scale-down reference image data;
generating second high-frequency reference image hierarchical data using the first scale-down reference image data;
scaling down the first scale-down reference image data using the second scale-down ratio to generate second scale-down reference image data;
outputting the second scale-down reference image data as the low-frequency reference image hierarchical data; and
generating third high-frequency reference image hierarchical data using the second scale-down reference image data.

4. The method as claimed in claim 3, wherein the generating the motion vector comprises:
generating a plurality of hierarchical motion vectors;
generating first expanded current image hierarchical data by expanding the low-frequency current image hierarchical data by a first expansion ratio; and
generating second expanded current image hierarchical data by expanding the low-frequency current image hierarchical data by a second expansion ratio.

5. The method as claimed in claim 4, wherein generating the plurality of motion vectors comprises:
estimating a third hierarchical motion vector using the third high-frequency current image hierarchical data, the third high-frequency reference image hierarchical data, the low-frequency current image hierarchical data and the low-frequency reference image hierarchical data;
estimating a second hierarchical motion vector using the second high-frequency current image hierarchical data, the second high-frequency reference image hierarchical data, the first expanded current image hierarchical data, the low-frequency reference image hierarchical data and the third hierarchical motion vector; and
estimating a first hierarchical motion vector using the first high-frequency current image hierarchical data, the first high-frequency reference image hierarchical data, the second expanded current image hierarchical data, the low-frequency reference image hierarchical data and the second hierarchical motion vector.

6. The method as claimed in claim 5, wherein estimating the third hierarchical motion vector comprises:
calculating a first SAD(3) using the third high-frequency current image hierarchical data and the third high-frequency reference image hierarchical data;
calculating a second SAD(3) using the low-frequency current image hierarchical data and the low-frequency reference image hierarchical data;
calculating SAD(3) satisfying SAD(3)=A3×first SAD(3)+B3×second SAD(3); and
outputting a motion vector having a minimum value among the values of SAD(3) as the third hierarchical motion vector, where A3 and B3 are arbitrary constants.

7. The method as claimed in claim 6, wherein calculating the second SAD(3) comprises:
searching predetermined points represented by the low-frequency reference image hierarchical data for points corresponding to predetermined points represented by the low-frequency current image hierarchical data;
calculating absolute values of differences between the searched points; and accumulating the absolute values.

8. The method as claimed in claim 5, wherein estimating the second hierarchical motion vector comprises:
calculating a first SAD(2) using the second high-frequency current image hierarchical data and the second high-frequency reference image hierarchical data;
calculating a second SAD(2) using the first expanded current image hierarchical data and the low-frequency reference image hierarchical data;
calculating SAD(2) satisfying SAD(2)=A2×first SAD(2)+B2×second SAD(2)+C2×MV3; and
outputting a motion vector having a minimum value among the values of SAD(2) as the second hierarchical motion vector, where A2, B2 and C2 are constants and MV3 is the third hierarchical motion vector.

9. The method as claimed in claim 8, wherein calculating the second SAD(2) comprises:
searching predetermined points represented by the low-frequency reference image hierarchical data for points corresponding to predetermined points represented by the first expanded current image hierarchical data;
calculating absolute values of differences between the searched points; and accumulating the absolute values.

10. The method as claimed in claim 5, wherein estimating the first hierarchical motion vector comprises:
calculating a first SAD(1) using the first high-frequency current image hierarchical data and the first high-frequency reference image hierarchical data;
calculating a second SAD(1) using the second expanded current image hierarchical data and the low-frequency reference image hierarchical data;
calculating SAD(1) satisfying SAD(1)=A1×first SAD(1)+B1×second SAD(1)+C1×MV2; and
outputting a motion vector having a minimum value among the values of SAD(1) as the first hierarchical motion vector, where A1, B1 and C1 are constants and MV2 is the second hierarchical motion vector.

11. The method as claimed in claim 10, wherein calculating the second SAD(1) comprises:
searching predetermined points represented by the low-frequency reference image hierarchical data for points corresponding to predetermined points represented by the second expanded current image hierarchical data;
calculating absolute values of differences between the searched points; and
accumulating the absolute values.

12. A multi-resolution motion estimator comprising:
a first data processing block outputting
first hierarchical data with respect to a current image, second hierarchical data with respect to an image obtained by scaling down the current image by a first scale-down ratio,
second scale-down image data obtained by scaling down the current image by a second scale-down ratio, and
third hierarchical data with respect to the second scale-down image data;
a second data processing block outputting
fourth hierarchical data with respect to a reference image,
fifth hierarchical data with respect to an image obtained by scaling down the reference image by the first scale-down ratio,
fourth scale-down image data obtained by scaling down the reference image by the second scale-down ratio, and
sixth hierarchical data with respect to the fourth scale-down image data; and
a motion estimation block respectively generating motion vectors at a plurality of levels using the first through sixth hierarchical data, the second scale-down image data and the fourth scale-down image data, the motion vectors being generated at the respective levels using hierarchical data having exclusive characteristic among the first through sixth hierarchical data, the second scale-down image data and the fourth scale-down image data.

13. The multi-resolution motion estimator as claimed in claim 12, wherein the hierarchical data having exclusive characteristic is hierarchical data representative of neighbouring pixels having a large difference between them and hierarchical data representative of neighbouring pixels having a negligible difference between them.

14. The multi-resolution motion estimator of claim 12, wherein the first scale-down ratio is 1/4 and the second scale-down ratio is 1/16.

15. The multi-resolution motion estimator of claim 12, wherein the first through sixth hierarchical data are 1-bit data and the second scale-down image data, and the fourth scale-down image data are data composed of at least two bits.

16. The multi-resolution motion estimator as claimed in claim 12, wherein the first data processing block comprises:
a first filter outputting first scale-down image data obtained by scaling down the current image by the first scale-down ratio;
a second filter outputting the second scale-down image data obtained by scaling down the current image by the second scale-down ratio using the first scale-down image data;
a first quantizer transforming the current image into the first hierarchical data;
a second quantizer transforming the first scale-down image data into the second hierarchical data; and
a third quantizer transforming the second scale-down image data into the third hierarchical data.

17. The multi-resolution motion estimator as claimed in claim 12, wherein the second data processing block comprises:
a third filter outputting third scale-down image data obtained by scaling down the reference image by the first scale-down ratio;
a fourth filter outputting the fourth scale-down image data obtained by scaling down the third scale-down image data by the second scale-down ratio;
a fourth quantizer transforming the reference image into the fourth hierarchical data;
a fifth quantizer transforming the third scale-down image data into the fifth hierarchical data; and
a sixth quantizer transforming the fourth scale-down image data into the sixth hierarchical data.

18. The multi-resolution motion estimator as claimed in claim 12, wherein the motion estimation block comprises:
an expander expanding the second scale-down image data in a first expansion ratio to generate first expanded image data and expanding the second scale-down image data to a size of the current image to generate second expanded image data, wherein the first expansion ratio is a reciprocal of the first scale-down ratio;
a first hierarchical motion estimation unit generating a first motion vector using the first hierarchical data, the fourth hierarchical data, the fourth scale-down image data, the second expanded image data and a second motion vector;
a second hierarchical motion estimation unit generating the second motion vector using the second hierarchical data, the fifth hierarchical data, the fourth scale-down image data, the first expanded image data and a third motion vector; and
a third hierarchical motion estimation unit generating the third motion vector using the third hierarchical data, the sixth hierarchical data, the second scale-down image data and the fourth scale-down image data.

19. The multi-resolution motion estimator as claimed in claim 18, wherein the first and second expanded image data are provided as a 16×16 array and the fourth scale-down image data is provided as a 4×4 array.

20. The multi-resolution motion estimator as claimed in claim 19, wherein the first hierarchical motion estimation unit obtains a first SAD using the first hierarchical data and the fourth hierarchical data and obtains a second SAD using the fourth scale-down image data and the second expanded image data, the first hierarchical motion estimation unit searching the second expanded image data for data corresponding to the fourth scale-down image data to obtain the second SAD.

21. The multi-resolution motion estimator as claimed in claim 20, wherein SAD(1) satisfying SAD(1)=A1×first SAD+B1×second SAD+C1×MV2 is calculated for blocks in a search region and a motion vector having a minimum value among the values of the SAD(1) is output as the first motion vector, A1, B1 and C1 being constants and set such that the SAD(1) has optimum values, MV2 representing the second motion vector.

22. The multi-resolution motion estimator as claimed in claim 19, wherein the second hierarchical motion estimation unit obtains a third SAD using the second hierarchical data and the fifth hierarchical data and obtains a fourth SAD using the fourth scale-down image data and the first expanded image data, the second hierarchical motion estimation unit searching the first expanded image data for the data corresponding to the fourth scale-down image data to obtain the fourth SAD.

23. The multi-resolution motion estimator as claimed in claim 22, wherein SAD(2) satisfying SAD(2)=A2×third SAD+B2×fourth SAD+C2×MV3 is calculated for blocks in a search region and a motion vector having a minimum value among the values of the SAD(2) is output as the second motion vector, where A2, B2 and C2 are constants and set such that the SAD(2) has optimum values and MV3 is the third motion vector.

24. An article of manufacture having a machine-accessible medium including data that, when accessed by a machine, cause the machine to:
generate a plurality of high-frequency current image hierarchical data representative of a high frequency component of the current image;
generate a plurality of low-frequency current image hierarchical data representative of a low frequency component of the current image;
generate a plurality of high-frequency reference image hierarchical data representative of a high frequency component of the reference image;
generate a plurality of low-frequency reference image hierarchical data representative of a low frequency component of the reference image using the reference image; and
generate the motion vector using the plurality of high-frequency current image hierarchical data, the plurality of low-frequency current image hierarchical data, the plurality of high-frequency reference image hierarchical data and the plurality of low-frequency reference image hierarchical data.

25. An image data processor executing a method for generating a motion vector for compressing a current image using a plurality of hierarchical data using the current image and a plurality of hierarchical data using a reference image, the method comprising:
generating a plurality of high-frequency current image hierarchical data representative of a high frequency component of the current image;
generating a plurality of low-frequency current image hierarchical data representative of a low frequency component of the current image;
generating a plurality of high-frequency reference image hierarchical data representative of a high frequency component of the reference image;
generating a plurality of low-frequency reference image hierarchical data representative of a low frequency component of the reference image; and
generating the motion vector using the plurality of high-frequency current image hierarchical data, the plurality of low-frequency current image hierarchical data, the plurality of high-frequency reference image hierarchical data and the plurality of low-frequency reference image hierarchical data.
